(19) United States
(12) Patent Application Publication
(10) Pub. No.: US 2006/0096823 A1
(43) Pub. Date: May 11, 2006

(54) Damper disc assembly

(75) Inventors: Masahiro Maeda, Yamatokooriyama (JP); Hiroshi Mizukami, Neyagawa (JP)

Correspondence Address: SHINJYU GLOBAL IP COUNSELORS, LLP, 1233 20TH STREET, NW, SUITE 700, WASHINGTON, DC, 20036-2680, US

(73) Assignee: EXEDY Corporation, Neyagawa (JP)

(21) Appl. No.: 11/269,591

(22) Filed: Nov. 9, 2005

(30) Foreign Application Priority Data
Nov. 10, 2004 (JP) JP 2004-326636
Feb. 14, 2005 (JP) JP2005-036200

(51) Int. Cl. F16H 45/02

(52) U.S. Cl. 192/3.29

(57) ABSTRACT

A damper disc assembly 42 is provided to reduce the number of components in the torque converter. The damper disc assembly 42 absorbs and dampens torsional vibration as well as transmits torque, and includes a driven member 53, a drive member 52, torsion springs 54, and a friction generation mechanism 71. The drive member 52 includes a pair of plate members 56 and 57 fixed to each other. Each of the plate members 56 and 57 is located on either axial side of the driven member 53 to be rotatable relative to the driven member 53. The torsion springs 54 connect the driven member 53 and the drive member 52 in the rotational direction. The friction generation mechanism 71 generates friction when the driven member 53 and the drive member 52 rotate relative to each other. An urging force that is an elastic force of at least one of the plate members 56 and 57 is applied to a friction surface of the friction generation mechanism 71.

### CROSS-REFERENCE TO RELATED APPLICATIONS

This application claims priority to Japanese Patent Application Nos. JP2004-326636 and JP2005-036200. The entire disclosures of Japanese Patent Application Nos. JP2004-326636 and JP2005-036200 are hereby incorporated herein by reference.

### BACKGROUND OF THE INVENTION

1. Field of the Invention

The present invention generally relates to a damper disc assembly. More specifically, the present invention relates to a damper disc assembly having a first rotational plate member and a second rotational plate member having of a pair of plate members fixed to each other and located on either axial side of the first rotational plate member.

2. Background Information

The damper disc assembly is employed as a part of a torque transmission apparatus of a vehicle such as a clutch disc assembly, a flywheel assembly, and a lock-up device of a torque converter. The damper disc assembly absorbs and dampens torsional vibrations as well as transmitting torque.

The torque converter will be explained and later the damper disc assembly in the lock-up device will be explained.

The torque converter is a device having three kinds of vane wheels (an impeller, a turbine, and a stator) in its interior. The torque converter transmits torque by rotating working oil inside of the vane wheels. The impeller is fixed to a front cover connected to an input-side rotational member. The turbine is connected to an input shaft of the transmission. When the impeller is rotated, the working fluid flows from the impeller toward the turbine to rotate the turbine. As a result, the turbine outputs torque to the input shaft of the transmission.

The lock-up device is located between the turbine and the front cover and mechanically connects the front cover and the turbine in order to transmit directly torque. Typically, the lock-up device is made of a piston that can be frictionally engaged with the front cover, and a damper disc assembly that elastically connects the piston and a turbine hub of the turbine. The damper disc assembly in Japanese Unexamined Patent Publication No. 2002-195376 includes, for example, a first rotational plate member engaged with the piston, a second rotational plate member including a pair of plate members located on either axial side of the first rotational plate member and fixed to each other, and torsion springs to connect elastically the first and second rotational plate members in the rotational direction. The second rotational plate member is fixed to the turbine. The torsional springs are supported in the axial direction by the pair of the plate members.

Conventionally, some lock-up devices include a friction generation mechanism to generate friction or hysteresis torque when the torsion springs are compressed in the rotational direction. For example, the friction generation mechanism includes washers disposed between the first rotational plate member and the second rotational plate member, such as a conical spring on the second rotational plate member side and a friction plate on the first rotational plate member side. The friction plate is unrotatably engaged with one of the plate members by claws thereof. The friction plate has a surface on the first rotational plate member-side onto which a slide member having a high coefficient of friction is attached. In addition, another slide member is disposed between the other of plate members and the first rotational plate members. In the above-mentioned structure, the slide member on the friction plate is urged by the conical spring against the first rotational plate member.

In the above-mentioned structure of the friction generation mechanism, the number of the components is not small and it is necessary to keep a satisfactory axial space for accommodating the conical spring.

In view of the above, it will be apparent to those skilled in the art from this disclosure that there exists a need for an improved damper disc assembly. This invention addresses this need in the art as well as other needs, which will become apparent to those skilled in the art from this disclosure.

### SUMMARY OF THE INVENTION

It is an object of the present invention to reduce the number of components and reduce the axial space of the damper disc assembly.

A damper disc assembly according a first aspect of the present invention absorbs and dampens torsional vibration as well as transmits torque. The damper disc assembly has a first rotational plate member, a second rotational plate member, an elastic member, and a friction generation mechanism. The second rotational plate member includes a pair of plate members fixed to each other. Each of the plate members is located on either axial side of the first rotational plate member to be rotatable relative to the first rotational plate member. The elastic member connects the first rotational plate member and the second rotational plate member in the rotational direction. The friction generation mechanism generates friction when the first and second rotational plate members rotate relative to each other. An urging force that is an elastic force of at least one of the plate members is applied to a friction surface of the friction generation mechanism.

In this damper disc assembly, a conventional urging member can be omitted because the plate member applies the urging force to the friction surface of the friction generation mechanism.

A damper disc assembly according to a second aspect of the present invention is the assembly of the first aspect, wherein the friction generation mechanism includes a friction member disposed between the first rotational plate member and the plate member. In this damper disc assembly, the friction member slides against the first rotational plate member or the plate member in the rotational direction.

A damper disc assembly according to a third aspect of the present invention is the assembly of the second aspect, wherein the friction generation mechanism further includes a plate to which the friction member is fixed. The plate is unrotatably engaged with the first rotational plate member or the plate member. In this damper disc assembly, the friction member rotates integrally with the plate and slides against other members.

A damper disc assembly according to a fourth aspect of the present invention is the assembly of the third aspect, wherein the plate is formed with a claw engaging with a cutout of the first rotational plate member or the plate members. In this damper disc assembly, the plate is engaged with other members in the rotational direction by its claw. The claw and cutout can be engaged so that they are not relatively rotatable.

A damper disc assembly according to a fifth aspect of the present invention is the assembly of the fourth aspect, wherein, a rotational gap is defined between the claw and the cutout such that the friction generation mechanism does not operate in response to torsional vibrations whose operation range is within the rotational gap. In this damper disc assembly, the friction generation mechanism does not generate friction in response to torsional vibration whose operation range is within the rotational gap. Consequently, it is possible to absorb effectively minute torsional vibration resulting from rotational fluctuation of the engine because the claw rotates relative to the cutout.

A damper disc assembly according to a sixth aspect of the present invention is the assembly of any one of the third to fifth aspects, wherein the plate is in contact with the first rotational plate member and unrotatably engaged with the first rotational plate member. The friction member is in contact with the plate member such that the friction member can slide against the plate member in the rotational direction. In this damper disc assembly, the friction surface is arranged between the slide member and the plate member. Consequently, it is possible to ensure an adequate friction surface area even when it is impossible to ensure enough flat surface on the first rotational plate member.

In the damper disc assembly according to the present invention, an urging member can be omitted because the plate member applies the urging force to the friction surface of the friction generation mechanism.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a cross-sectional view of a torque converter in accordance with a first preferred embodiment of the present invention;

FIG. 2 is an enlarged partial view of FIG. 1 and a sectional view illustrating a friction generation mechanism;

FIG. 3 is a partial elevational view illustrating the engagement of a friction plate and a driven member of the torque converter;

FIG. 4 is a partial elevational view illustrating a variation of the engagement of the friction plate and the driven member;

FIG. 5 is a partial elevational view illustrating an engagement of the friction plate and the driven member in accordance with a second preferred embodiment;

FIG. 6 is an enlarged partial view of FIG. 1 and a sectional view illustrating a friction generation mechanism;

FIG. 7 is a partial elevational view illustrating the engagement of a friction plate and a driven member of the torque converter;

FIG. 8 is a partial elevational view illustrating a variation of the engagement of the friction plate and the driven member ; and

FIG. 9 shows an inner circumference portions 56c and 57c of a first plate member 56 and a second plate member 57 in a free state.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

(1) Overall Structure of the Torque Converter

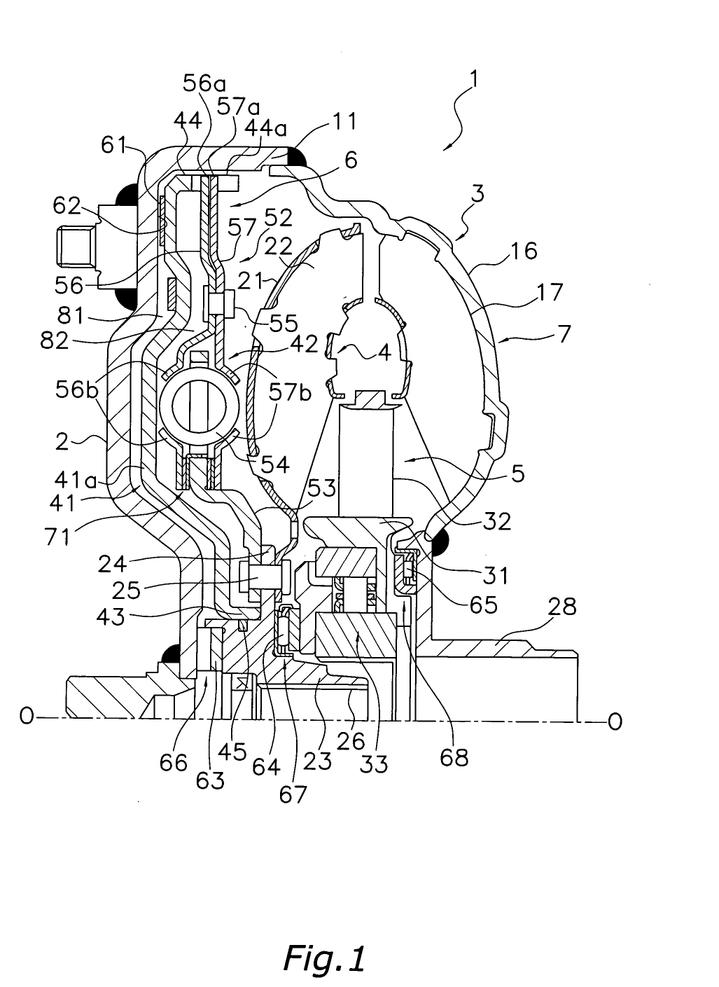

A cross-sectional view of a torque converter 1 in accordance with a first preferred embodiment of the present invention is shown in FIG. 1. A line O-O is a rotational axis of the torque converter 1. The torque converter 1 mainly is made of a front cover 2, an impeller 3, a turbine 4, a stator 5, and a lock-up device 6. The front cover 2 is attachable to a structural component not shown in figures on the engine side so that the torque is inputted from the engine. The front cover 2 is formed with an outer projection 11 at the radially outer edge thereof. The outer projection 11 is bent and extends in the axial direction in the opposite direction to the engine not shown, i.e., toward the transmission. The impeller 3 has an impeller shell 16 and a plurality of impeller blades 17 fixed to the impeller shell 16. The impeller shell 16 is fixed to the outer projection 11 of the front cover 2, thereby forming a fluid chamber. The turbine 4 is arranged to oppose axially the impeller 3 in the fluid chamber. The turbine 4 includes a turbine shell 21 and a plurality of turbine blades 22 fixed onto the turbine shell 21. The turbine 4 further includes a turbine hub 23 having a flange 24 to transmit torque to the transmission not shown in figures. A radially inner periphery of the turbine shell 21 is fixed to the flange 24 of the turbine hub 23 by rivets 25. The turbine hub 23 is formed with spline teeth 26 inside to engage with the main drive shaft (not shown) of the transmission. The stator 5 adjusts the direction of flow of the working oil returning from the turbine 4 to the impeller 3. The stator 5 is located between inner circumference portions of the impeller 3 and the turbine 4. The stator 5 includes a stator shell 31 and a plurality of stator blades 32 formed on the stator shell 31. The stator 5 is radially inwardly supported by a one-way clutch 33 on an unrotatable shaft (not shown). The impeller 3, the turbine 4 and the stator 5 as mentioned form a torus fluid operation chamber 7.

A thrust washer 63 is disposed axially between the inner circumference portions of the front cover 2 and the turbine hub 23. A first port 66 is formed around the thrust washer 63, allowing the working oil to flow both ways in the radial direction. In other words, the first port 66 establishes a communication between an oil path formed within the main drive shaft, and a front chamber 81 between the front cover 2 and the piston 41.

A thrust bearing 64 is disposed axially between the turbine hub 23 and the radially inner portion of the stator 5, more specifically, the one-way clutch 33. A second port 67 is formed around the thrust bearing 64, allowing the working oil to flow both ways in the radial direction. In other words, the second port 67 establishes a communication between the fluid operation chamber 7 and an oil path that is formed between the main drive shaft and the unrotatable shaft (not shown).

A thrust bearing 65 is disposed axially between the stator 5 and the impeller 3, more specifically between the stator shell 31 and an impeller hub 28. A third port 68 is formed around the thrust bearing 65, allowing the working oil to flow both ways in the radial direction. In other words, the third port 68 establishes a communication between the fluid operation chamber 7 and an oil path which is formed between the unrotatable shaft and the impeller hub 28

Each of the oil paths is connected to an oil hydraulic circuit not shown in figures and is able to supply the oil to and drain the oil from the ports 66 to 68 independently.

(2) Structure of the Lock-up Device

The lock-up device 6 is a device to connect mechanically the front cover 2 and the turbine 4. The lock-up device 6 is axially located in a space between the front cover 2 and the turbine 4. The lock-up device 6 is mainly made of a piston 41 and a damper disc assembly 42.

The piston 41 is a disc-like member movable in the axial and circumferential directions and is located to separate a space between the front cover 2 and the turbine 4 into a front chamber 81 on the front cover 2 side and a rear chamber 82 on the turbine 4 side. The piston 41 is moved by an applied pressure, i.e., a differential pressure between the front chamber 81 and the rear chamber 82.

The piston 41 is made of a piston body 41 a having a disc shape, and further having a radially inner-side cylindrical portion 43 bent and extending toward the transmission at the radially inner edge and a radially outer-side cylindrical portion 44 bent and extending toward the transmission at the radially outer edge. The radially inner-side cylindrical portion 43 is supported by an outer circumference surface of the turbine hub 23 such that the piston 41 can move in the axial and circumferential directions. A seal ring 45 is disposed on the outer circumference surface of the turbine hub 23 so that the inner circumference portions of the front chamber 81 and the rear chamber 82 are sealed from each other by the seal ring 45.

A friction facing 61 is attached to a radially outward surface on the engine side of the piston body 41a. The front cover 2 has a portion facing the friction facing 61, and the portion is formed with a friction surface 62. The friction facing 61 is used to ensure frictional engagement between the piston 41 and the front cover 2. When the friction facing 61 and the friction surface 62 come into contact with each other and are frictionally engaged, torque is transmitted from the front cover 2 to the piston 41. If the slip control is employed, it is possible to control torque transmission from the front cover 2 to the piston body 41a.

The damper disc assembly 42 includes a drive member 52 including a pair of plate members 56 and 57, a driven member 53, and a plurality of torsion springs 54.

The plate members 56 and 57 are arranged in the axial direction. Outer circumference portions of the plate members 56 and 57 are fixed to each other by rivets 55. Radially outer edges of the plate member 56 and 57 are formed with a plurality of projections 56a and 57a extending radially outward to engage with projections 44a formed on the radially outer-side cylindrical portion 44. This engagement makes it possible for the piston 41 and the drive member 52 to rotate integrally but move relative to each other in the axial direction. In addition, the plate members 56 and 57 have inner circumference portions at a distance in the axial direction. The inner circumference portions of the plate members 56 and 57 are respectively formed with a plurality of cut-and-raised portions 56b and 57b. The cut-and-raised portions 56b and 57b support the torsion springs 54.

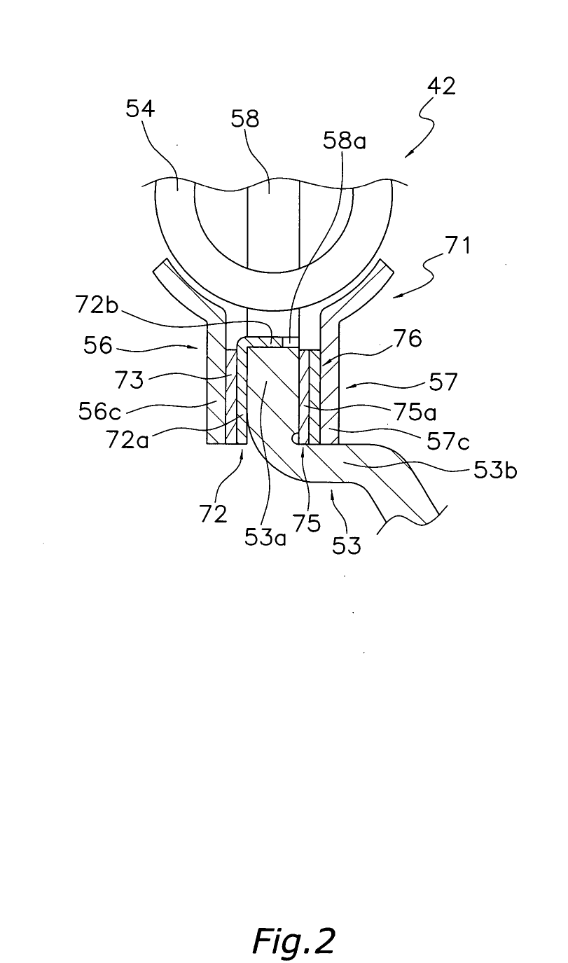

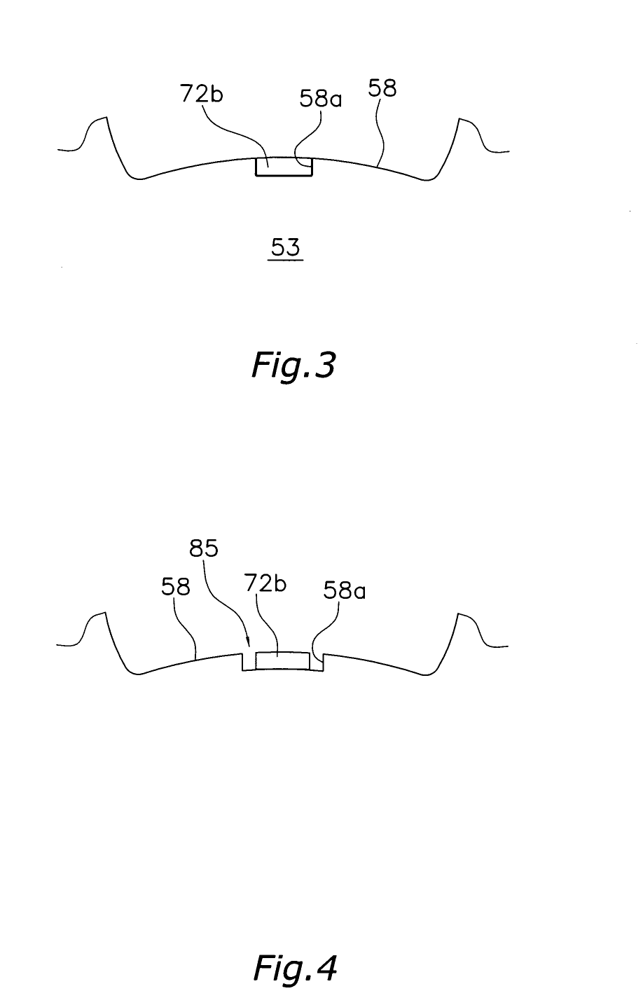

The driven member 53 is a disc-like member and is located axially between the inner circumference portions of the plate members 56 and 57, and the inner circumference portion of the driven member 53 is fixed to the flange 24 by the rivets 25. The driven member 53 is formed with window holes 58 corresponding to the cut-and-raised portions 56b and 57b. The window holes 58 extend in the circumferential direction. As shown in FIGS. 2 and 3, a cutout 58a dented radially inward is formed at the radially inner edge of the window hole 58.

The torsion springs 54 are coil springs extending in the circumferential direction and accommodated within the window holes 58 and the cut-and-raised portions 56b and 57b. The torsion springs 54 have circumferential ends supported by circumferential ends of the cut-and-raised portions 56b and 57b. Furthermore, each torsion spring 54 is supported by the cut-and-raised portions 56b and 57b in the axial direction.

Next, the friction generation mechanism 71 will be explained. The friction generation mechanism 71 generates friction or hysteresis torque when the plate members 56 and 57 and the driven member 53 rotate relative to each other and the torsion springs 54 are compressed in the rotational direction. The friction generation mechanism 71 is functionally located between the drive member 52 and the driven member 53 to operate in parallel with the torsion springs 54.

As shown in FIG. 2, the friction generation mechanism 71 is located radially inward of the torsion springs 54 and between the driven member 53 and the plate members 56 and 57. The friction generation mechanism 71 has washers, as later described, such as a first friction plate 72 and a second friction plate 75 disposed between an inner circumference portion 53a of the driven member 53 and inner circumference portions 56c and 57c of the plate member 56 and 57.

The first friction plate 72 is disposed between the inner circumference portion 53a of the driven member 53 and the inner circumference portion 56c of the first plate member 56. The first friction plate 72 is an annular thin plate member and is in contact with an axially engine-side surface of the inner circumference portion 53a of the driven member 53. A first friction washer 73 is attached to an axially engine-side surface of the first friction plate 72 and is in contact with the inner circumference portion 56c of the first plate member 56. The first friction washer 73 is made of a material of high coefficient of friction such as resin. Further, the first friction plate 72 is formed with a plurality of claws 72b at the radially outer edge of a main body 72a. As shown in FIG. 3, each claw 72b is bent toward the transmission in the axial direction and is inserted into a corresponding cutout 58a of the window hole 58 in the driven member 53 so that the first friction plate 72 rotates integrally with the driven member 53.

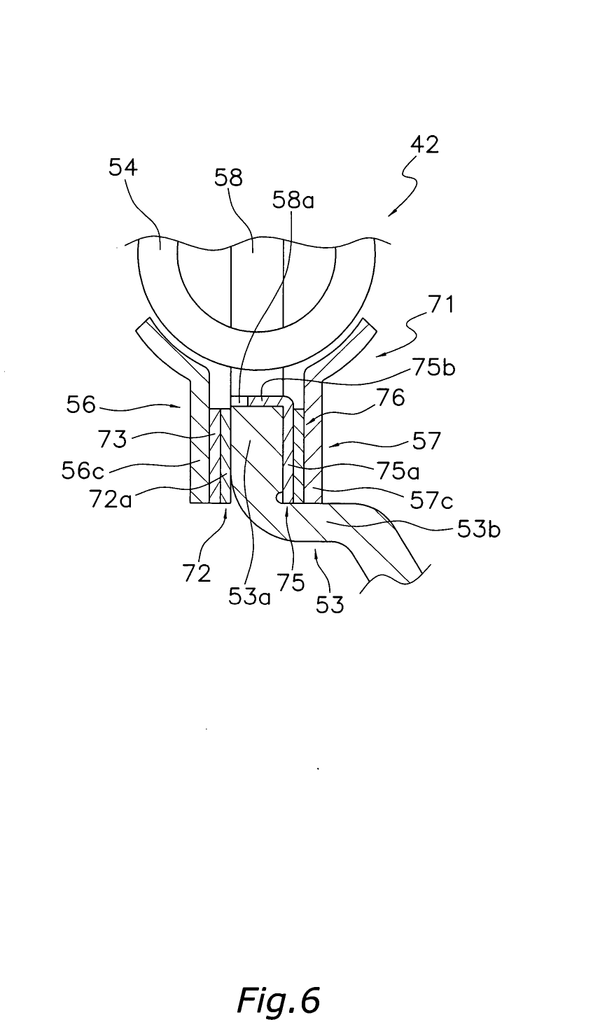

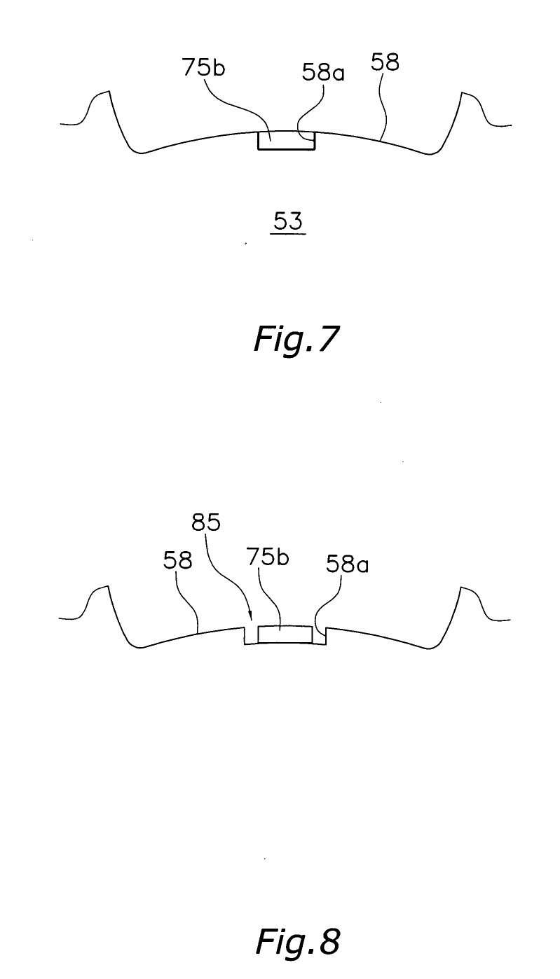

As shown in FIG. 6, the second friction plate 75 is disposed between the inner circumference portion 53a of the driven member 53 and an inner circumference portion 57c of the second plate member 57. The second friction plate 75 is an annular thin plate member and is in contact with an axially transmission-side surface of the inner circumference portion 53a of the driven member 53. A second friction washer 76 is attached to an axially transmission-side surface of the second friction plate 75 and is in contact with the inner circumference portion 57c of the second plate member 57. The second friction washer 76 is made of a material with a high friction coefficient such as resin. Further, the second friction plate 75 is formed with a plurality of claws 75b at the radially outer edge of a main body 75a. As shown in FIG. 7, each claw 75b is bent toward the engine in the axial direction and is inserted into a cutout 58a of the window hole 58 in the driven member 53 so that the second friction plate 75 rotates integrally with the driven member 53. The claws 72b and 75b are located in different positions in the rotational direction.

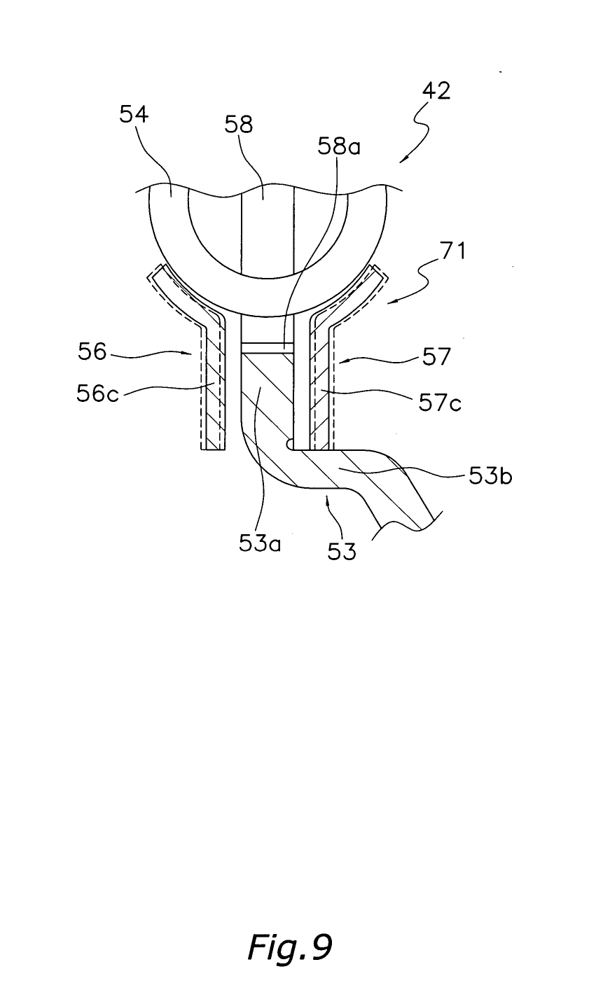

The first plate member 56 and the second plate member 57 generate a pressing load by elastic force in the inner circumference portions 56c and 57c, which is the most inner area, i.e., an area corresponding to the friction generation mechanism 71. In other words, in a free state shown in FIG. 9, the inner circumference portions 56c and 57c of the first plate member 56 and the second plate member 57 are nearer to the each other when compared to the flat state shown in FIG. 2. As a result, the first plate member 56 and the second plate member 57 hold or sandwich the first friction plate 72 and the second friction plate 75 by applying pressure directed toward each other in the axial direction. In this damper disc assembly 42, the plate members 56 and 57 apply an urging force to the friction surface of the friction generation mechanism 71 so that an urging member can be omitted. Consequently, the number of the components is reduced and the axial space is also reduced.

In the damper disc assembly 42, the friction surfaces are defined between the first friction washer 73 and the plate member 56, and also between the second friction washer 76 and the plate member 57. Accordingly, it is possible to ensure an adequate or superior friction surface area even if it is impossible to ensure a flat area for the friction surface on the driven member 53. In this embodiment, the driven member 53 is formed with a cylindrical portion 53b forming a curved portion near the radially inner portion of the friction generation mechanism 71, so that the above-mentioned structure produces an advantageous effect. In addition, in this embodiment, an inner circumference of the second plate member 57 of the drive member 52 is in contact with and supported by an outer circumference of the cylindrical portion 53b. In other words, the drive member 52 is positioned in the radial direction or centered by the cylindrical portion 53b of the driven member 53.

In this embodiment, the claws 72b and 75b are engaged with the cutouts 58a of the driven member 53 with no gap in the rotation direction as shown in FIG. 3. In a variation, they may be engaged with each other with a small gap 85 in the rotational direction as shown in FIG. 4 and FIG. 8. In this variation, the friction generation mechanism 71 does not operate in the range of the rotational gap 85. In other words, no sliding occurs in the friction generation mechanism 71 in response to minute torsional vibration whose operation range or angle is smaller than the rotational gap 85 between the cutouts 58a and the claws 72b and 75b. Consequently, it is possible to absorb effectively minute torsional vibration caused by the rotational fluctuation of the engine.

(3) Operation of the Torque Converter

Referring to FIG. 1, after the start of the engine operation, the working oil is supplied into the torque converter 1 through the first port 66 and the third port 68 and is drained through the second port 67. The working oil supplied through the first port 66 flows radially outward in the front chamber 81 and passes through the rear chamber 82 and flows into the fluid operation chamber 7. By the differential pressure between the front chamber 81 and the rear chamber 82, the piston 41 has moved toward the transmission side in the axial direction. In this state, the friction facing 61 is separated from the front cover 2, thereby releasing the lock-up. In the above-mentioned lock-up release state, torque is transmitted between the front cover 2 and the turbine 4 through a fluid drive with the impeller 3 and the turbine 4.

(4) Operation of the Lock-up Device

When the speed ratio of the torque converter 1 increases and rotational speed of the main drive shaft reaches a predetermined level, the working oil is drained from the front chamber 81 through the first port 66. As a result, by the differential pressure, the piston 41 is moved toward the front cover 2 and the friction facing 61 is pressed against the flat friction surface 62 of the front cover 2. Consequently, the torque of the front cover 2 is transmitted from the piston 41 to the driven member 53 through the drive member 52 and the torsion springs 54. Then, the torque is transmitted from the driven member 53 to turbine hub 23. In summary, the front cover 2 is mechanically connected to the turbine 4, and the torque of the front cover 2 is directly transmitted to the input shaft of the transmission through the turbine 4.

During the above-mentioned lock-up engagement state, the lock-up device 6 absorbs and dampens the torsional vibration inputted from the front cover 2 as well as transmitting torque. More specifically, when the torsional vibration is inputted into the lock-up device 6, the torsion springs 54 are compressed in the rotational direction between the drive member 52 and the driven member 53. In the friction generation mechanism 71, the first friction washer 73 slides against the first plate member 56 in the rotational direction, and the second friction washer 76 slides against the second plate member 57 in the rotational direction, thereby generating high hysteresis torque.

In the variation shown in FIG. 4, when minute torsional vibrations are inputted within the angular range of the gap 85, the first and second friction plates 72 and 75 rotate integrally with the drive member 52 and rotate relative to the driven member 53. In other words, in the range corresponding to the gap 85, the friction washers 73 and 76 do not slide against the members on either side, and thereby do not generate high hysteresis. As mentioned, in the case of the torsional vibrations with small amplitude such as the rotational fluctuation of the engine causing noises during the driving, the friction washers 73 and 76 neither slide nor generate high hysteresis torque by means of the gap 85 having a minute torsional angle. Consequently, the rotational fluctuation of the engine is sufficiently absorbed and the noise during the driving is unlikely to occur.

As used herein, the following directional terms “forward, rearward, above, downward, vertical, horizontal, below, and transverse” as well as any other similar directional terms refer to those directions of a device equipped with the present invention. Accordingly, these terms, as utilized to describe the present invention should be interpreted relative to a device equipped with the present invention.

### Alternate Embodiments

Alternate embodiments will now be explained. In view of the similarity between the first and alternate embodiments, the parts of the alternate embodiment that are identical to the parts of the first embodiment will be given the same reference numerals as the parts of the first embodiment. Moreover, the descriptions of the parts of the alternate embodiment that are identical to the parts of the first embodiment may be omitted for the sake of brevity.

(5) Second Embodiment

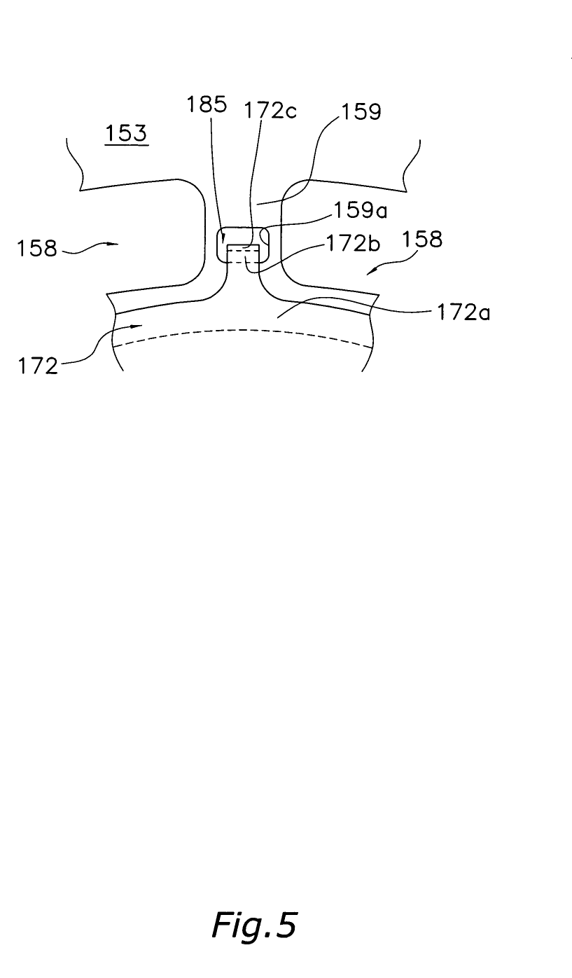

Referring to FIG. 5, the second embodiment of the present invention will be explained. A plurality of claws 172b is formed at a radially outer edge of a main body 172a of a first friction plate 172. As shown in FIG. 5, the claw 172b extends radially outward and the tip is bent toward the transmission in the axial direction and is inserted into a penetrating hole 159a formed in a portion 159 between adjacent window holes 158. Accordingly, the first friction plate 172 rotates integrally with the driven plate 153.

In FIG. 5, a small gap 185 is defined between the tip 172c of the claw 172b and circumferential ends of the penetrating hole 159a. In this case, the friction generation mechanism does not operate in the range of the gap 185. In other words, no sliding occurs in the friction generation mechanism in response to minute torsional vibration having an operation angle which is smaller than the rotational gap 185 between the claw 172b and the penetrating hole 159a. Consequently, it is possible to absorb effectively the minute torsional vibration caused by the rotational fluctuation of the engine.

(6) Other Embodiments

The above-mentioned embodiments are examples of the present invention so that it is possible to have variations within a scope of the gist of the present invention.

The structure of the friction generation mechanism is not limited to the above-mentioned embodiments. The friction plate and the friction washer may be located on only one of the axial sides of the driven member, wherein a spacer may be disposed on the other of the axial sides of the driven member.

The friction plate may be engaged with the plate member of the drive member, wherein the friction washer may slide against the driven member in the rotational direction.

The shape of the engagement portion with the friction plate claw on the driven member or the drive member may be a rectangular hole.

The friction generation mechanism may be located radially outward of the torsion springs.

The friction plate may be omitted. In this case, the friction washer may be fixed to one of the plate member and the driven member, or may not be fixed to either of them.

The pair of plate member may be driven-side members, wherein the member between them may be a drive-side member.

The structure of the lock-up device is not limited to the above-mentioned embodiments. For example, the present invention can be applied to a lock-up device including a multiple clutch having a plurality of plates between the piston and the front cover.

The present invention may be applied to other types of fluid torque transmission device having a lock-up device such as a fluid coupling as well as the torque converter.

The present invention may be applied to other types of the damper disc assembly such as a clutch disc assembly and a flywheel assembly as well as the lock-up device.

The term “configured” as used herein to describe a component, section, or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A damper disc assembly being configured to absorb and to dampen torsional vibrations and to transmit torque, comprising:
a first rotational plate member;
a second rotational plate member including a pair of plate members fixed to each other, each of said pair of plate members being located on either axial side of the first rotational plate member to be rotatable relative to said first rotational plate member;
an elastic member being configured to connect said first rotational plate member and said second rotational plate member in the rotational direction; and
a friction generation mechanism being configured to generate friction when said first and second rotational plate members rotate relative to each other, at least one of said pair of plate members being configured to apply an elastic force in an axial direction to a friction surface of said friction generation mechanism.

2. The damper disc assembly according to claim 1, wherein said friction generation mechanism includes a friction member disposed between said first rotational plate member and at least one of said pair of plate members.

3. The damper disc assembly according to claim 2, wherein said friction generation mechanism further includes a friction plate to which said friction member is attached, said friction plate being unrotatably engaged with said first rotational plate member or one of said pair of plate members.

4. The damper disc assembly according to claim 3, wherein said friction plate is formed with a claw engaging with a cutout of said first rotational plate member or one of said pair of plate members.

5. The damper disc assembly according to claim 2, wherein said friction generation mechanism further includes a friction plate to which said friction member is attached, said friction plate being engaged with said first rotational plate member or one of said pair of plate members such that a rotational gap is defined between said claw and said cutout such that said friction generation mechanism does not operate in response to torsional vibrations whose operation range is within said rotational gap.

6. The damper disc assembly according to claim 5, said friction plate is in contact with said first rotational plate member and unrotatably engaged with said first rotational plate member, and
said friction member is in contact with said friction plate such that said friction member can slide against said plate member in the rotational direction.

7. The damper disc assembly according to claim 4, said friction plate is in contact with said first rotational plate member and unrotatably engaged with said first rotational plate member, and
said friction member is in contact with said friction plate such that said friction member can slide against said plate member in the rotational direction.

8. The damper disc assembly according to claim 3, said friction plate is in contact with said first rotational plate member and unrotatably engaged with said first rotational plate member, and
said friction member is in contact with said friction plate such that said friction member can slide against said plate member in the rotational direction.

9. A torque converter comprising:
a front cover;
an impeller being fixed to said front cover;
a turbine being arranged axially between said front cover and said impeller;
a stator being arranged axially between said turbine and said impeller; and
a lockup device being arranged axially between said front cover and said turbine to connect and to disconnect mechanically said front cover to said turbine, said lockup device having a piston and a damper disc assembly being configured to absorb and to dampen torsional vibrations and to transmit torque, said damper disc assembly having
a first rotational plate member,
a second rotational plate member including a pair of plate members fixed to each other, each of said pair of plate members being located on either axial side of the first rotational plate member to be rotatable relative to said first rotational plate member,
an elastic member being configured to connect said first rotational plate member and said second rotational plate member in the rotational direction, and
a friction generation mechanism being configured to generate friction when said first and second rotational plate members rotate relative to each other, at least one of said pair of plate members being configured to apply an elastic force in an axial direction to a friction surface of said friction generation mechanism.

10. The torque converter according to claim 9, wherein said friction generation mechanism includes a friction member disposed between said first rotational plate member and at least one of said pair of plate members.

11. The torque converter according to claim 10, wherein said friction generation mechanism further includes a friction plate to which said friction member is attached, said friction plate being unrotatably engaged with said first rotational plate member or one of said pair of plate members.

12. The torque converter according to claim 11, wherein said friction plate is formed with a claw engaging with a cutout of said first rotational plate member or one of said pair of plate members.

13. The torque converter according to claim 10, wherein said friction generation mechanism further includes a friction plate to which said friction member is attached, said friction plate being engaged with said first rotational plate member or one of said pair of plate members such that a rotational gap is defined between said claw and said cutout such that said friction generation mechanism does not operate in response to torsional vibrations whose operation range is within said rotational gap.

14. The torque converter according to claim 13, said friction plate is in contact with said first rotational plate member and unrotatably engaged with said first rotational plate member, and
said friction member is in contact with said friction plate such that said friction member can slide against said plate member in the rotational direction.

15. The torque converter according to claim 12, said friction plate is in contact with said first rotational plate member and unrotatably engaged with said first rotational plate member, and
said friction member is in contact with said friction plate such that said friction member can slide against said plate member in the rotational direction.

16. The torque converter according to claim 11, said friction plate is in contact with said first rotational plate member and unrotatably engaged with said first rotational plate member, and
said friction member is in contact with said friction plate such that said friction member can slide against said plate member in the rotational direction.
